(19) United States
(12) Patent Application Publication
(10) Pub. No.: US 2013/0153815 A1
(43) Pub. Date: Jun. 20, 2013

(54) POLYMER COMPRISING A DYE, NANOPARTICLE COMPRISING THE POLYMER, AND METHODS OF PREPARING THE SAME

(71) Applicant: Agency for Science, Technology and Research, Singapore (SG)

(72) Inventors: Swee Kuan Yen, Singapore (SG); Tamil Selvan, Subramanian (SG); Dominik Janczewski, Singapore (SG)

(73) Assignee: Agency for Science, Technology and Research, Singapore (SG)

(21) Appl. No.: 13/684,357

(22) Filed: Nov. 23, 2012

(30) Foreign Application Priority Data
Nov. 25, 2011 (SG) 201108731-9

(51) Int. Cl. G01N 27/00; C08F 22/06

(52) U.S. Cl. CPC G01N 27/00; C08F 22/06
USPC 252/62.54; 525/327.5; 525/351

(57) ABSTRACT

The present invention relates to a polymer functionalized with a dye, a nanoparticle comprising the dye-functionalized polymer on its surface, as well as to methods of preparing the same. In particular, it relates to a bimodal imaging agent, comprising said nanoparticles functionalized with a polymer bearing a dye with luminescence properties, and fabrication methods of the same.

### CROSS-REFERENCE TO RELATED APPLICATION

This application claims the benefit of priority of Singapore Patent Application No. 201108731-9, filed Nov. 25, 2011, the contents of which being hereby incorporated by reference in its entirety for all purposes.

### TECHNICAL FIELD

The present invention relates to a polymer functionalized with a dye, a nanoparticle comprising the dye-functionalized polymer on its surface, as well as to methods of preparing the same. In particular, it relates to a bimodal imaging agent, comprising said nanoparticles functionalized with a polymer bearing a dye with luminescence properties, and fabrication methods of the same.

### BACKGROUND

Various research groups have reported on the use of nanocrystals or quantum dots in bioimaging applications. Of these, magnetic-fluorescent optical bimodal probes have been developed previously by using magnetic nanoparticles (MNPs) and cadmium selenide (CdSe)-based quantum dots. CdSe-based quantum dots have good fluorescence properties.

Although CdSe-based quantum dots have good fluorescence properties, CdSe is toxic and this has limited its application to in vivo biological study. Furthermore, the leakage of Cd ions through the shell defects is another issue. Producing and employing Cd-related compounds will damage the environment and eventually harm human health.

In view of the above, there is a need for an improved imaging agent which may be used for bioimaging purposes. In particular, there is a need for an improved bimodal imaging agent having both magnetic and luminescence properties which may be used for bioimaging purposes.

### SUMMARY

The present invention is based on the inventors' discovery that nanoparticles coated with polymers having dye moieties possess excellent luminescent properties, good water solubility and photochemical stability. In particular, the dye moieties are modified to form dye-functionalized polymers. In various embodiments, magnetic nanoparticles coated with such polymers functionalized with near infrared dye moieties have been found to be useful as magnetic-fluorescent optical bimodal probes in bioimaging.

Thus, a first aspect of the invention relates to a polymer comprising repeat units of the general formulae (I), (II) and (III):

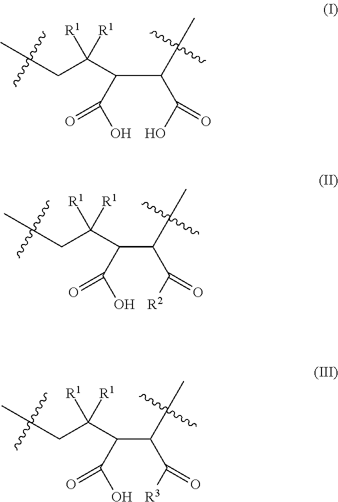

or salts thereof,
wherein:
the repeat unit of general formula (I) is comprised in the polymer with a number of m units, the repeat unit of general formula (II) is comprised in the polymer with a number of o units and repeat unit of general formula (III) is comprised in the polymer with a number of p units, wherein each of m, o and p is an independently selected integer from about 3 to about 400 and wherein the sum of m+o+p is selected in the range from about 10 to about 10,000,
R¹ in repeat units (I) to (III) is H or methyl,
R² in repeat unit (II) is an aliphatic moiety with a main chain of about 3 to about 30 carbon atoms and 0 to about 3 heteroatoms selected from the group N, O, S, Se and Si, and,
R³ in repeat unit (III) is an optionally substituted dye molecule.

In one embodiment, the polymer has the following structure

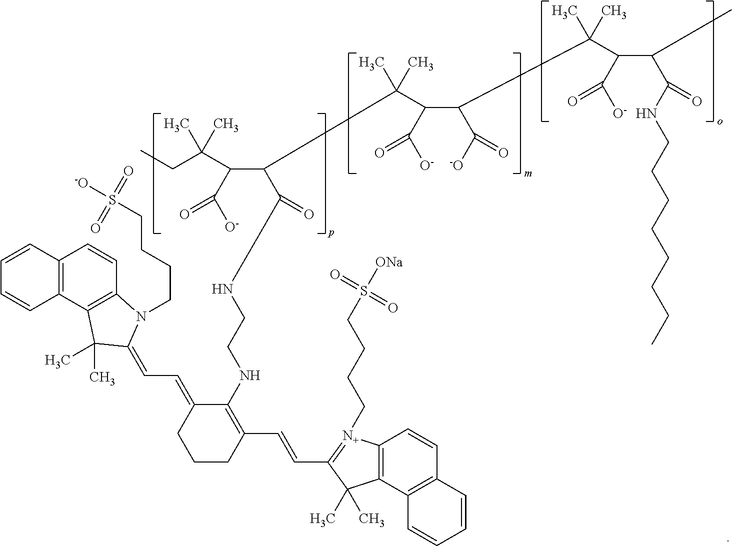

A second aspect of the invention relates to a method of producing a polymer of the first aspect, comprising reacting in a suitable solvent a maleic anhydride polymer of formula (IV),

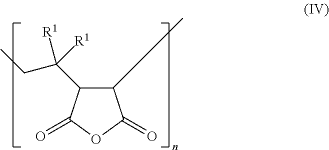

with an optionally substituted dye molecule and an alkylamine,
wherein:
n is an integer from about 10 to about 10,000, and
R¹ is H or methyl.

In a third aspect of the invention, there is disclosed a nanoparticle comprising on its surface a polymer according to the first aspect, wherein the nanoparticle is a magnetic nanocrystal.

In one embodiment, the nanoparticle comprises on its surface a polymer having the following structure

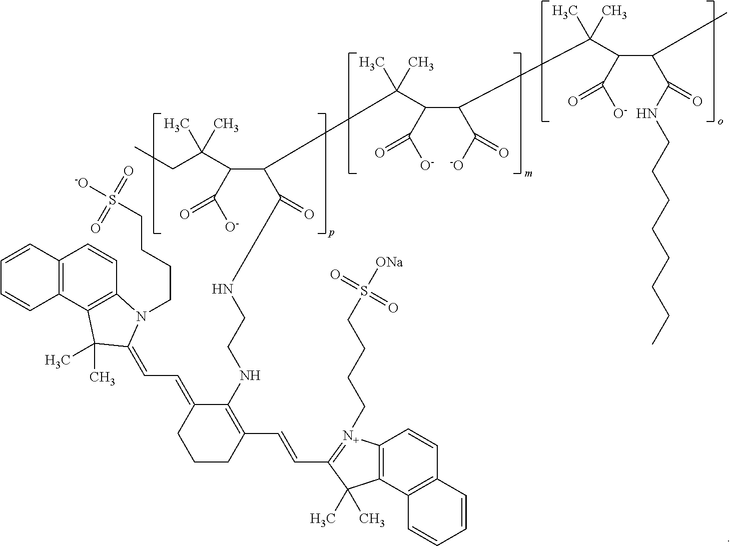

A fourth aspect of the invention relates to a method of producing a nanoparticle comprising on its surface a polymer, the method comprising:
(i) providing a nanoparticle in a suitable solvent, wherein the nanoparticle is a magnetic nanocrystal,
(ii) contacting the nanoparticle with a polymer according to the first aspect, and
(iii) allowing interaction between the polymer and the nanoparticle, thereby forming the nanoparticle comprising on its surface said polymer.

In a fifth aspect of the invention, a method of providing an imaging agent for use in magnetic resonance imaging or bioimaging is disclosed, wherein the imaging agent comprises a nanoparticle of the third aspect.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 shows a schematic of the reaction replacing the meso-chlorine atom of heptamethine cyanine dyes with ethylenediamine producing amine-functionalized moiety.

FIG. 2 shows the synthesis reactions of the IR820dye-NH₂ and n-octylamine with poly(isobutylene-alt-maleic anhydride) where Dye-Pol 1: short backbone chain (average Mw ˜6,000 g/mol) and Dye-Pol 2: long backbone chain (average Mw ˜60,000 g/mol).

FIG. 3 shows the coating reactions of magnetic nanoparticles (MNPs) with Dye-Pol 1 and Dye-Pol 2. The resultant Dye-Pol 1 and Dye-Pol 2 coated nanoparticles are denoted as MNP@Dye-Pol 1 and MNP@Dye-Pol 2, respectively, where the symbol “@” is used to denote coating of the dye-functionalized polymers Dye-Pol 1 and Dye-Pol 2 on the surface of the MNP.

FIG. 4 shows a high resolution TEM image of MNPs coated with Dye-Pol 1.

FIG. 5 shows a high resolution TEM image of MNPs coated with Dye-Pol 2.

FIG. 6 shows the UV absorption of (a) IR-820, (b) IR820dye-NH₂, (c) Dye-Pol 2 and (d) Dye-Pol 1 in methanol (MeOH) (0.1 mM, 25° C.).

FIG. 7 shows the UV absorption of (a) Dye-Pol 1 and (b) Dye-Pol 2 in PBS buffer and after 3 days in PBS buffer.

FIG. 8 shows the UV absorption of (a) MNP 1 and (b) MNP 2 in PBS buffer and after 3 days in PBS buffer.

FIG. 9 shows the NIR photoluminescence (PL) spectra of (a) IR-820, (b) IR820dye-NH₂, (c) Dye-Pol 1 and (d) Dye-Pol 2 excited with a 785 nm laser diode.

FIG. 10 shows the NIR photoluminescence (PL) spectra of (a) MNP 1 (MNP@Dye-Pol 1) and (b) MNP 2 (MNP@Dye-Pol 2) excited with a 785 nm laser diode.

FIG. 11 shows in vitro cell viability of HeLa cells in presence of (a) MNP 1 and (b) MNP 2 at specified concentration upon exposure to different incubation time. For comparison, CdSe quantum dots (QDs) were used. QD 1: and QD 2 were coated with similar polymers. Peroxide: control.

FIG. 12 shows HeLa cells incubated with the particles for 24 hours at 37° C. Cell viability assay was carried out after the 24 hours incubation. The cell viability was estimated using WST-8 assay in triplicate. The error bars indicate mean square standard deviations. Control: no particles added.

FIG. 13 shows HeLa cells incubated with the particles for 6 hours at 37° C. Particles were then removed and cells were further incubated in complete media for 48 hours. Cell viability assay was carried out after the 48 hours incubation. Control: no particles added.

FIG. 14 shows examples of suitable NIR dyes alternative to IR-820.

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

The present invention relates to the functionalization of magnetic-fluorescent optical bimodal probes suitable for bioimaging or biolabeling applications. The technology is based on the application of water soluble magnetic nanoparticles (MNPs) functionalized with polymers bearing modified dye moieties and the MNPs coating mechanism is based on hydrophobic/hydrophobic interactions.

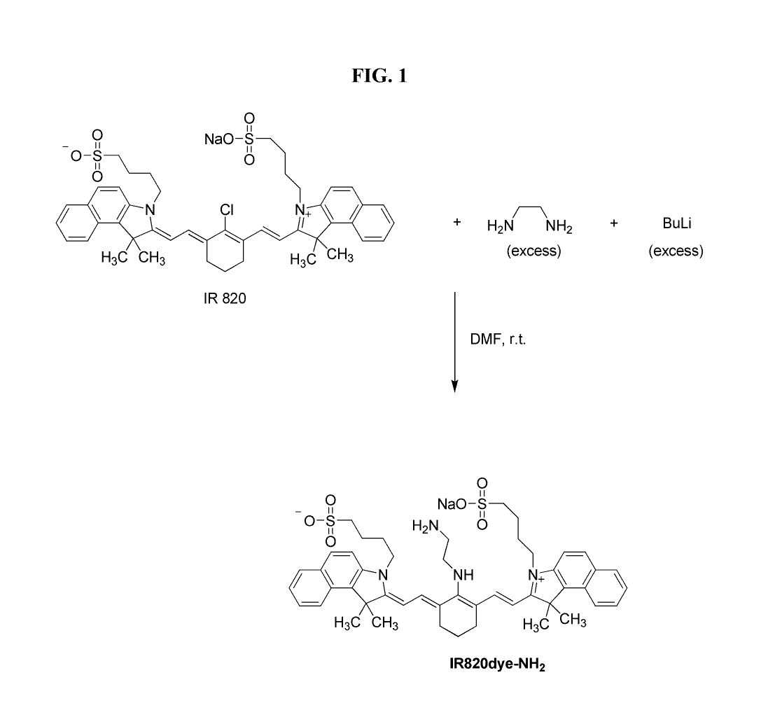

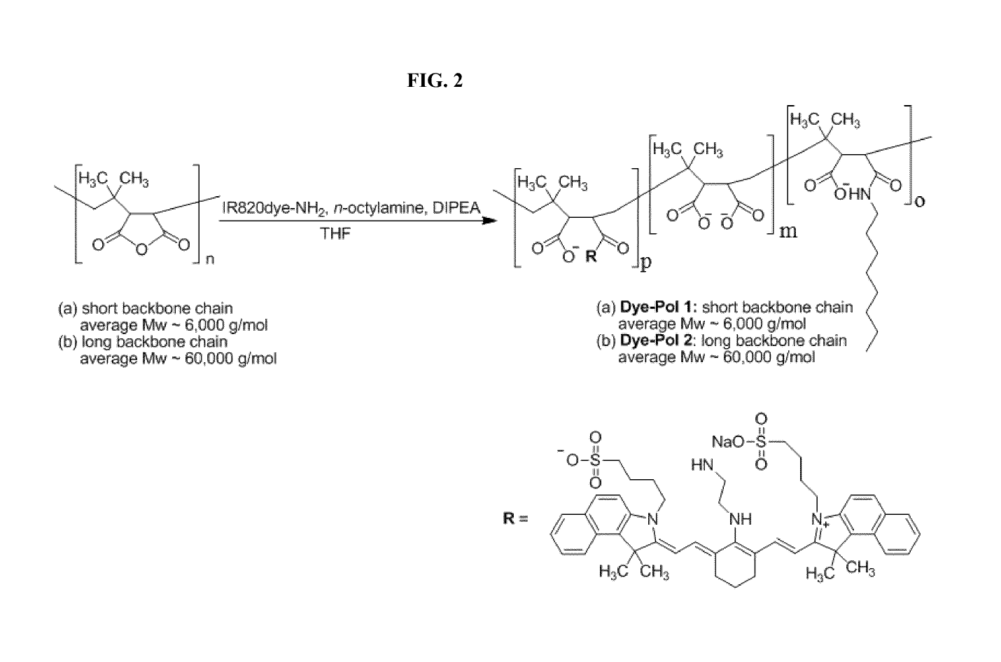

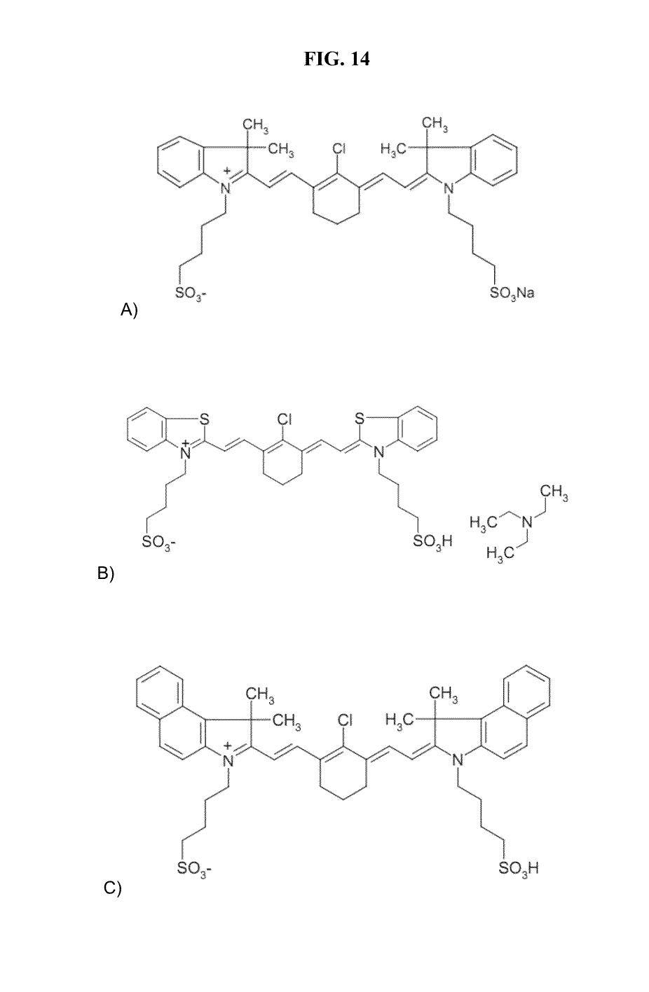

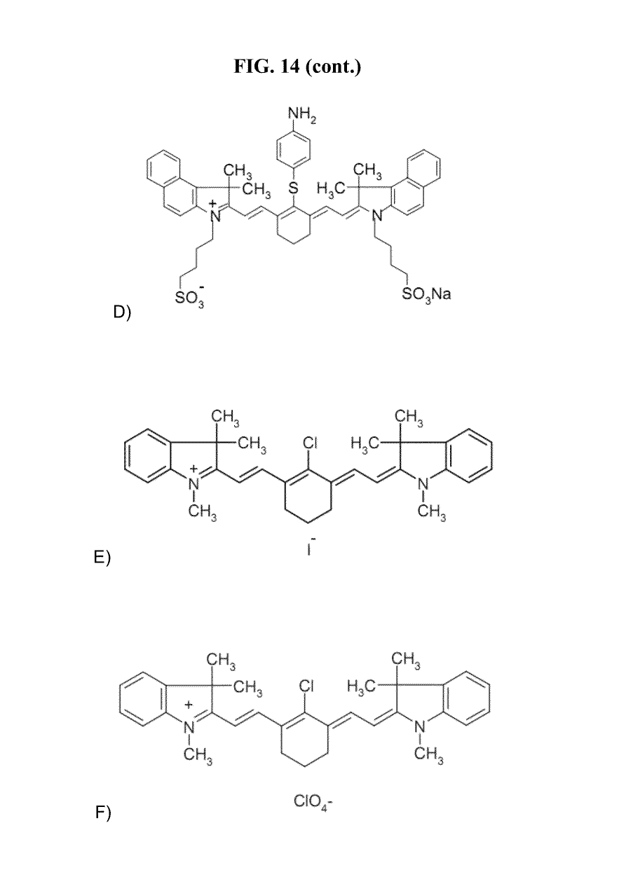

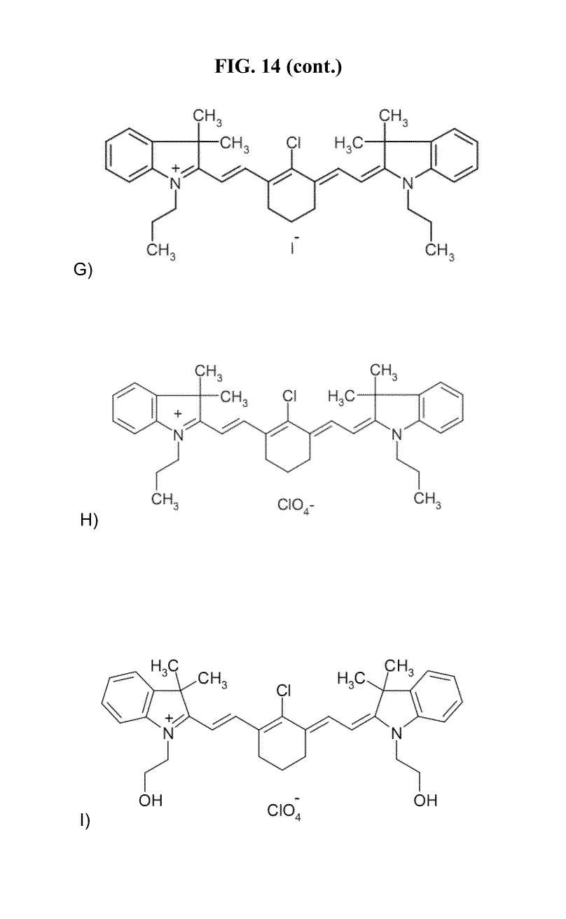

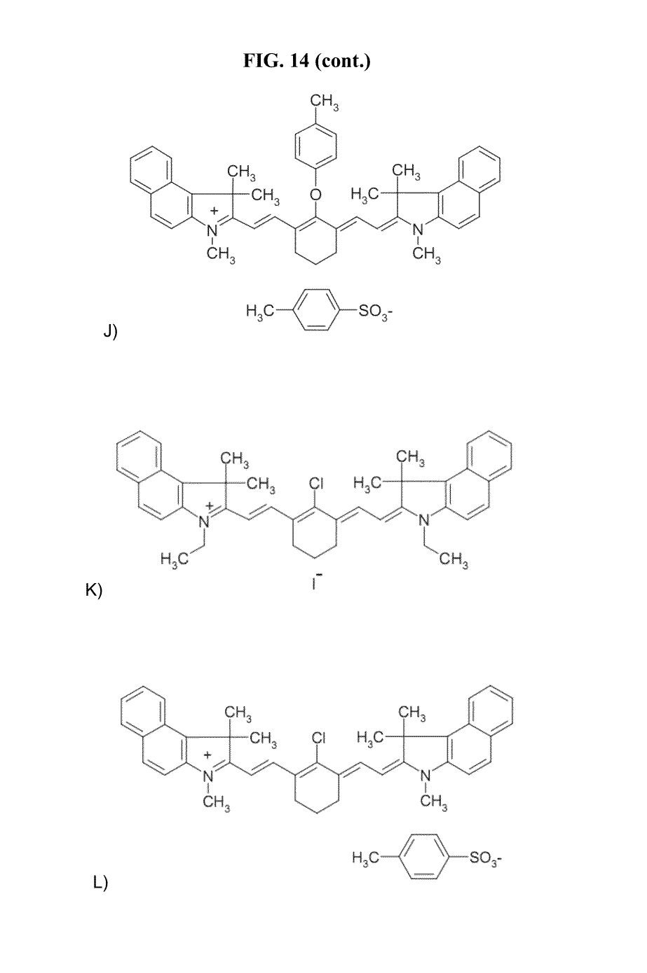

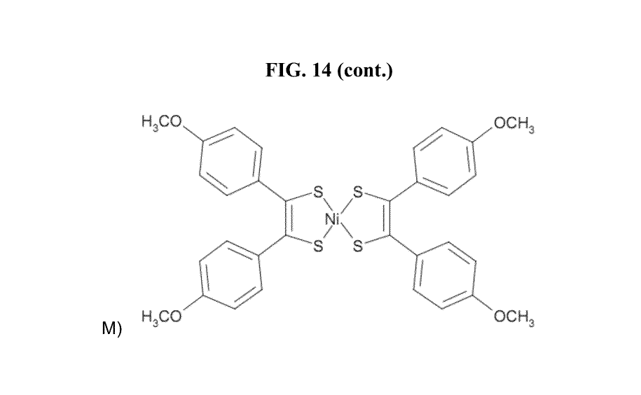

In an exemplary illustration shown in FIG. 1, the functionalization is carried out on the central meso-chloro cyclohexenyl group of near infrared (NIR) heptamethine cyanine fluorochrome IR-820 (a dye) whereby the meso-chloro atom is replaced by ethylenediamine and a high yield of the modified dye is obtained. It is to be understood and appreciated that the illustration of FIG. 1 serves to facilitate the understanding of the present invention and does not restrict the invention in any way. For example, FIG. 14 shows a non-exhaustive list of dye molecules (Compounds (A)-(M)) suitable for modification for use in the present invention.

Briefly, IR-820 is reacted with excess ethylenediamine and excess butyllithium (BuLi) in the presence of dimethylformamide (DMF) to form the modified dye, denoted as IR820dye-NH₂. The modified dye molecule retains the benefits of NIR dyes, such as good water solubility and photochemical stability, as well as provides an amine group for further reaction with polymers in different backbone chain. Therefore, it is possible to obtain a variety of NIR-dye-functionalized polymers by a convenient general method. By introducing NIR-dye onto the MNPs surface, it helps to replace existing bimodal labels based on toxic fluorescent CdSe quantum dots in vivo biological study.

NIR fluorescent probes (600-1000 nm) have several advantages, including but not limited to:
(i) NIR light has deep photon penetration in tissues because it is poorly absorbed by hemoglobin, water and lipids,
(ii) the background autofluorescence is negligible,
(iii) the light scattering in tissue is relatively low because scattering decreases with the wavelength.

The modified dyes are then incorporated into polymers to form dye-functionalized polymers.

Thus, a first aspect of the invention relates to a polymer comprising repeat units of the general formulae (I), (II) and (III):

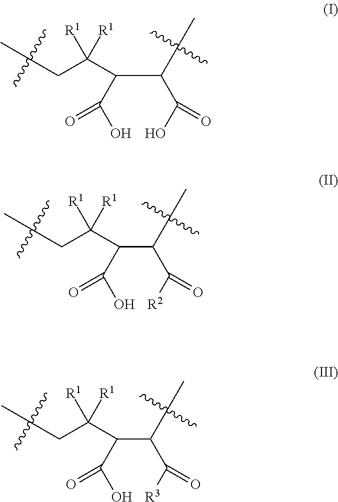

or salts thereof,
wherein:
the repeat unit of general formula (I) is comprised in the polymer with a number of m units, the repeat unit of general formula (II) is comprised in the polymer with a number of o units and repeat unit of general formula (III) is comprised in the polymer with a number of p units, wherein each of m, o and p is an independently selected integer from about 3 to about 400 and wherein the sum of m+o+p is selected in the range from about 10 to about 10,000,
R¹ in repeat units (I) to (III) is H or methyl,
R² in repeat unit (II) is an aliphatic moiety with a main chain of about 3 to about 30 carbon atoms and 0 to about 3 heteroatoms selected from the group N, O, S, Se and Si, and,
R³ in repeat unit (III) is an optionally substituted dye molecule.

The term “aliphatic” means, unless otherwise stated, a straight or branched hydrocarbon chain, which may be saturated, i.e. alkyl or alkylene, or mono- or poly-unsaturated and include heteroatoms (see above). An unsaturated aliphatic group contains one or more double and/or triple bonds (alkenyl or alkynyl moieties). The branches of the hydrocarbon chain may include linear chains as well as non-aromatic cyclic elements. The (main) chain of an aliphatic moiety (including bridge), may, unless otherwise stated, be of any length, and contain any number of branches. Typically, the hydrocarbon (main) chain includes 1 to about 5, to about 10, to about 15, to about 20, to about 30 or to about 40 carbon atoms. Examples of alkenyl radicals are straight-chain or branched hydrocarbon radicals which contain one or more double bonds. Alkenyl radicals normally contain about two to about twenty carbon atoms and one or more, for instance two, double bonds, such as about two to about ten carbon atoms, and one double bond. Alkynyl radicals normally contain about two to about twenty carbon atoms and one or more, for example two, triple bonds, such as two to ten carbon atoms, and one triple bond. Examples of alkynyl radicals are straight-chain or branched hydrocarbon radicals which contain one or more triple bonds. Examples of alkyl groups are methyl, ethyl, propyl, butyl, pentyl, hexyl, heptyl, octyl, nonyl, decyl, the n isomers of these radicals, isopropyl, isobutyl, isopentyl, neopentyl, sec.-butyl, tert.-butyl, neopentyl and 3,3-dimethylbutyl. Both the main chain as well as the branches may furthermore contain heteroatoms as for instance N, O, S, Se or Si or carbon atoms may be replaced by these heteroatoms.

The term “alicyclic” may also be referred to as “cycloaliphatic” and means, unless stated otherwise, a non-aromatic cyclic moiety (e.g. hydrocarbon moiety), which may be saturated or mono-or poly-unsaturated. The cyclic hydrocarbon moiety may also include fused cyclic ring systems such as decalin and may also be substituted with non-aromatic cyclic as well as chain elements. The main chain of the cyclic hydrocarbon moiety may, unless otherwise stated, be of any length and contain any number of non-aromatic cyclic and chain elements. Typically, the hydrocarbon (main) chain includes 3, 4, 5, 6, 7 or 8 main chain atoms in one cycle. Examples of such moieties include, but are not limited to, cyclopentyl, cyclohexyl, cycloheptyl, or cyclooctyl. Both the cyclic hydrocarbon moiety and, if present, any cyclic and chain substituents may furthermore contain heteroatoms, as for instance N, O, S, Se or Si, or a carbon atom may be replaced by these heteroatoms. The term “alicyclic” also includes cycloalkenyl moieties that are unsaturated cyclic hydrocarbons, which generally contain about three to about eight ring carbon atoms, for example five or six ring carbon atoms. Cycloalkenyl radicals typically have a double bond in the respective ring system. Cycloalkenyl radicals may in turn be substituted. Examples of such moieties include, but are not limited to, cyclohexenyl, cyclooctenyl or cyclodecenyl.

In contrast thereto, the term “aromatic” means an at least essentially planar cyclic hydrocarbon moiety of conjugated double bonds, which may be a single ring or include multiple condensed (fused) or covalently linked rings, for example, 2, 3 or 4 fused rings. The term aromatic also includes alkylaryl. Typically, the hydrocarbon (main) chain includes 5, 6, 7 or 8 main chain atoms in one cycle. Examples of such moieties include, but are not limited to, cyclopentadienyl, phenyl, napthalenyl-, [10]annulenyl-(1,3,5,7,9-cyclodecapentaenyl-), [12]annulenyl-, [8]annulenyl-, phenalene (perinaphthene), 1,9-dihydropyrene, chrysene (1,2-benzophenanthrene). An example of an alkylaryl moiety is benzyl. The main chain of the cyclic hydrocarbon moiety may, unless otherwise stated, be of any length and contain any number of heteroatoms, as for instance N, O and S. Such a heteroaromatic moietie may for example be a 5- to 7-membered unsaturated heterocycle which has one or more heteroatoms from the series O, N, S. Examples of such heteroaromatic moieties (which are known to the person skilled in the art) include, but are not limited to, furanyl-, thiophenyl-, naphtyl-, naphtho-furanyl-, anthrathiophenyl-, pyridinyl-, pyrrolyl-, quinolinyl, naphthoquinolinyl-, quinoxalinyl-, indolyl-, benzindolyl-, imidazolyl-, oxazolyl-, oxoninyl-, oxepinyl-, benzoxepinyl-, azepinyl-, thiepinyl-, selenepinyl-, thioninyl-, azecinyl-, (azacyclodecapentaenyl-), diazecinyl-, azacyclododeca-1,3,5,7, 9,11-hexaene-5,9-diyl-, azozinyl-, diazocinyl-, benzazocinyl-, azecinyl-, azaundecinyl-, thia[11]annulenyl-, oxacyclotrideca-2,4,6,8, 10,12-hexaenyl- or triazaanthracenyl-moieties.

By the term “arylaliphatic” is meant a hydrocarbon moiety, in which one or more aromatic moieties are substituted with one or more aliphatic groups. Thus the term “arylaliphatic” also includes hydrocarbon moieties, in which two or more aryl groups are connected via one or more aliphatic chain or chains of any length, for instance a methylene group. Typically, the hydrocarbon (main) chain includes 5, 6, 7 or 8 main chain atoms in each ring of the aromatic moiety. Examples of arylaliphatic moieties such as alkylaryl moieties include, but are not limited, to 1-ethyl-naphthalene, 1,1′-methylenebis-benzene, 9-isopropylanthracene, 1,2,3-trimethyl-benzene, 4-phenyl-2-buten-l-ol, 7-chloro-3-(1-methylethyl)-quinoline, 3-heptyl-furan, 6-[2-(2,5-diethylphenyl)ethyl]-4-ethyl-quinazoline or, 7,8-dibutyl-5,6-diethyl-isoquinoline.

Each of the terms “aliphatic”, “alicyclic”, “aromatic” and “arylaliphatic” as used herein is meant to include both substituted and unsubstituted forms of the respective moiety. Substituents my be any functional group, as for example, but not limited to, amino, amido, azido, carbonyl, carboxyl, cyano, isocyano, dithiane, halogen, hydroxyl, nitro, organometal, organoboron, seleno, silyl, silano, sulfonyl, thio, thiocyano, trifluoromethyl sulfonyl, p-toluenesulfonyl, bromobenzenesulfonyl, nitrobenzenesulfonyl, and methanesulfonyl.

The aliphatic and the optional alicyclic moieties, which the hydrocarbon backbone carries, may carry further moieties such as side chains. Such further moieties may be an aliphatic, alicyclic, aromatic, arylaliphatic or arylalicyclic group that typically is of a main chain length of 1 to about 10, to about 15 or to about 20 carbon atoms. These further moieties may also carry functional groups (supra).

Suitable dye molecules include those that can functionalize polymers incorporating the dye molecules, thereby imparting the dye properties to the dye-functionalized polymers. In various embodiments, the dye molecule is modified to incorporate reactive functional groups for coupling to the polymers. For example, the dye molecule is modified or functionalized with a bifunctional linker molecule for connecting to the repeat unit (III). The bifunctional linker molecule may be selected from the group consisting of a diamine, a dicarboxylic acid, a hydroxyl carboxylic acid, a dithiol, a dihydroxyl, an amine hydroxyl, an amine thiol, a hydroxylthiol, and an alkyl amine group. In certain embodiments, the bifunctional linker molecule is a diamine selected from the group consisting of ethylenediamine, 1,3-propanediamine, 1,4-butanediamine, spermidine, 2,4-diaminobutyric acid, lysine, 3,3′-diaminodipropylamine, diaminopropionic acid, N-(2-aminoethyl)-1,3-propanediamine, and 2-(4-aminophenyl)ethylamine.

In one embodiment, the bifunctional linker molecule is ethylenediamine.

In various embodiments, the dye molecule is a near infrared (NIR) dye. Examples of NIR dyes include, but are not limited to, xanthenes, fluorones, rhodamines, thioxanthone, thiazines, acridines, anthraquinones, cyanines, phthalocyanines, merocyanines, benzopyran, azo dyes, metal complex azo dyes, pyrazolone azo dyes, naphthoquinones, methine dyes, and squaliriums dyes. In certain embodiments, the NIR dye may be selected from the group consisting of indocyanine green, IR-820, IR-783, and mixtures thereof.

In one embodiment, the NIR dye is IR-820, whose chemical structure is illustrated in FIG. 1. The IR-820 dye may then be modified to form the following structure:

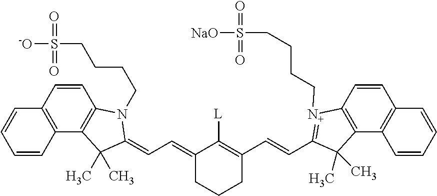

wherein L denotes a linker group for connecting the dye molecule to the remainder of the repeat unit (III) or denotes the attachment point to the remainder of the repeat unit (III).

In various embodiments, L is a linker group selected from the group consisting of —OR⁴, —NR⁴R⁵, —SR⁴, —O—C(O)—R⁴, and —R⁴,
wherein:
R⁴ is selected from the group consisting of —(CH₂)ₖ—, —(CH₂)ₖ—O—, —(CH₂)ₖ—NR⁵—, —(CH₂)ₖ—S—, and —(CH₂)ₖ—C(O)—O—,
R⁵ is hydrogen or C₁-C₆ alkyl, and
k is an integer from 1 to 10.

In one embodiment, L is —NR⁴R⁵, wherein R⁴ is —(CH₂)ₖ—NR⁵—, k is 2 and R⁵ is hydrogen. Accordingly, the modified dye molecule of R³ is

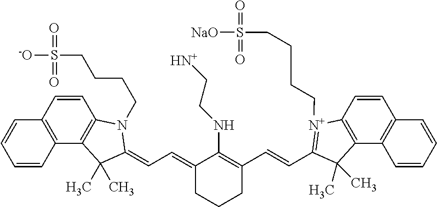

wherein the symbol “*” denotes the point at which R³ is connected to the remainder of the repeat unit (III).

Other suitable NIR dyes are illustrated as Compounds (A)-(M) in FIG. 14.

The first repeat unit may accordingly be taken to be represented by the general formulae (I) or (Ia):

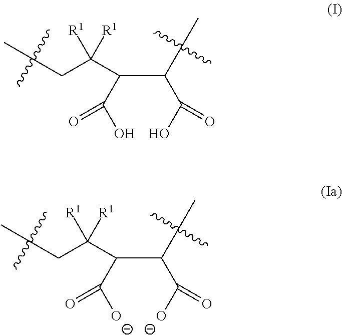

in which R¹ is H or methyl.

The second repeat unit may be taken to be represented by the general formulae (II) or (IIa):

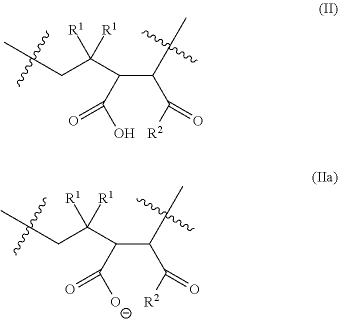

in which R¹ is H or methyl, and R² is an aliphatic moiety with a main chain of about 3 to about 30 carbon atoms and 0 to about 3 heteroatoms selected from the group consisting of N, O, S, Se and Si.

The third repeat unit may be taken to be represented by the general formulae (III) or (IIIa):

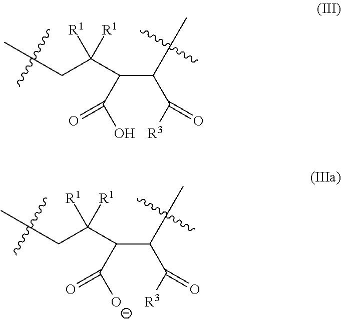

in which R¹ is H or methyl, and R³ is an optionally substituted dye molecule. The dye molecule may be modified to include reactive functional group (supra) for coupling to the polymer to thereby form the dye-functionalized polymer.

As can be taken from the above, formulae (Ia), (IIa), and (IIIa) merely show a salt of the corresponding carboxylic groups. It is understood that the representation of a carboxylic group includes any salt from thereof (the counter ion thus not being depicted above). Therefore representations of salt forms are in the following generally omitted, unless it appears beneficial in terms of clarity.

Each of m, o and p is an independently selected integer from 1 to about 400, including from 2 to about 400 or about 3 to about 400, such as about 4 to about 400, about 3 to about 350, about 2 to about 300, about 3 to about 300, about 3 to about 250, about 3 to about 200, about 2 to about 200, about 3 to about 150, about 2 to about 150, about 3 to about 200, about 1 to about 200, about 3 to about 100, about 2 to about 100, about 1 to about 100, about 3 to about 50, about 2 to about 50, about 1 to about 50 or about 4 to about 50. As further illustrations, m may in some embodiments be selected in the range from about 5 to about 50, such as about 10 to about 45 including about 10 to about 43, whereas p may for instance be selected in the range from about 3 to about 40, such as about 3 to about 35 or about 3 to about 30, and p may for example be selected in the range from 3 to about 30, such as from 3 to about 25 or from 3 to about 20. The sum of m+o+p is selected in the range from about 10 to about 10000, including about 10 to about 8000, about 10 to about 6000, about 10 to about 5000, about 10 to about 4000, about 10 to about 2000, about 10 to about 1000, about 10 to about 750, about 10 to about 600, about 10 to about 400, about 10 to about 250, about 10 to about 150, about 10 to about 100, about 15 to about 150, about 20 to about 150, about 15 to about 100, or about 20 to about 100. In some embodiments each of m, o and p is an independently selected integer from about 2 to about 300, including from about 3 to about 300, about 3 to about 250, about 3 to about 200, about 3 to about 150 or about 2 to about 200, about 3 to about 100, about 2 to about 100, about 3 to about 80, about 2 to about 80, about 3 to about 40 or about 2 to about 40 and the sum of (m+o+p) is selected in the range from about 6 to about 400, including from about 10 to about 400, from about 10 to about 350, from about 10 to about 300, from about 10 to about 250, from about 10 to about 200, from about 6 to about 200, from about 10 to about 150, from about 6 to about 150, from about 10 to about 100, from about 6 to about 100, from about 10 to about 50 or from about 6 to about 50. In one embodiment the sum of (m+o+p) is 50. In another embodiment the sum of (m+o+p) is 32. In yet another embodiment the sum of (m+o+p) is 48. The ratio of m/(o+p) may be selected in the range from 0 to about 25, such as from 0 to about 20, from 0 to about 15, from 0 to about 12, from 0 to about 10, from 0 to about 8, from about 0 to about 6, to about 4, to about 3 or to about 2. In one embodiment the ratio of m/(o+p) is about 1.

The polymer may comprise a short backbone chain having an average molecular weight of about 5,000 g/mol. Alternatively, the polymer may comprise a long backbone chain having an average molecular weight up to about 100,000 g/mol. The molecular weight of the polymer may be adjusted by manipulating the m, o and p values of the respective repeat units of formulae (I), (II) and (III). In an illustrative example given below, the average molecular weight of the polymer is about 6,000 g/mol where the sample consists of p=12, m=14 and o=4. In another illustrative example given below, the average molecular weight of the polymer is about 60,000 g/mol where the sample consists of p=100, m=230 and o=50.

In various embodiments, R² is —NRR′, —OR, or —SR, with R being selected from the group consisting of C₂-C₁₅ alkyl, C₂-C₁₅ alkenyl, and C₂-C₁₅ alkynyl, and R′ being hydrogen or C₁-C₆ alkyl, with the alkyl, alkenyl and alkynyl groups being optionally substituted.

In certain embodiments, R² is an alkylamino group, such as —NH(CH₂)₇CH₃.

In one preferred embodiment, the polymer has the following structure:

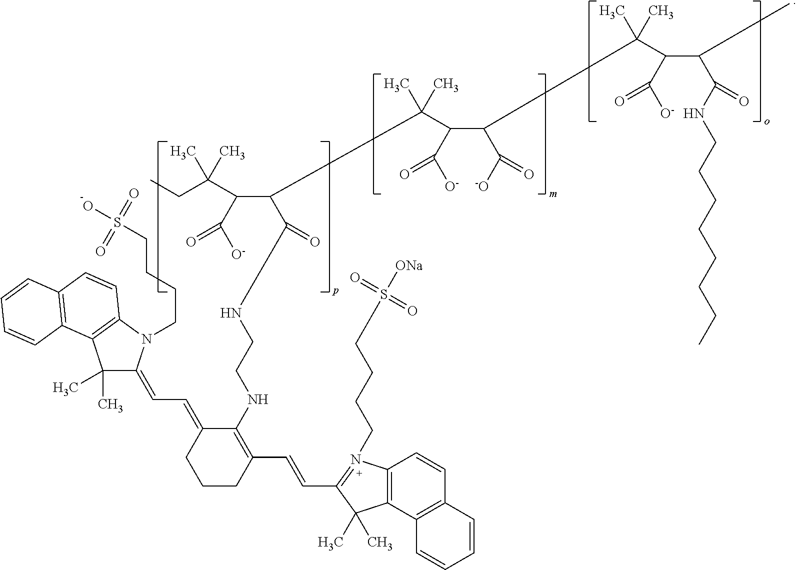

Advantageously, the polymer may display a Stokes shift value of greater than 100 nm.

In the process of forming a polymer according to the invention, a maleic anhydride polymer of formula (IV) is used as a reactant, which forms the backbone on the polymer. Thus, another aspect of the invention relates to a method of producing a polymer of the first aspect, comprising reacting in a suitable solvent a maleic anhydride polymer of formula (IV),

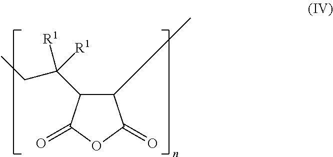

with an optionally substituted dye molecule and an alkylamine,
wherein:
n is an integer from about 10 to about 10,000, and
R¹ is H or methyl.

The maleic anhydride polymer may be the commercially available poly(isobutylene-alt-maleic anhydride) of Chemical Abstracts No. 26426-80-2, also termed isobutylene-maleic acid anhydride copolymer. It is inter alia available under the names BM 30AE20, Fibersorb™ SA 7200H, IB 6, KI Gel and Isobam®. It is available from e.g. Sigma-Aldrich (St. Louis, Mo., USA) or SinoChemexper Company (Shanghai, PRC). The maleic anhydride polymer may also be poly(ethylene-alt-maleic anhydride) of Chemical Abstracts No. 106973-21-1, also termed ethylene-maleic anhydride alternating copolymer. It is for example available from Rutherford Chemicals (Bayonne, N.J.) under product code 27109P, as well as under the names ZeMac® E 400 or ZeMac® E 60. In formula (IV) above, n may be any integer from about 10 to about 10000, such as about 10 to about 5000, about 10 to about 2000, about 10 to about 1000, about 20 to about 1000, about 10 to about 800, about 20 to about 800, such as about 10 to about 400. In one embodiment n is 50. In another embodiment n is 32. The above examples of maleic anhydride polymers are not to be considered as being limiting but every available maleic anhydride polymer (and also those yet to be synthesized), in particular a maleic anhydride polymer which may be prepared according to standard procedures as described are suitable to be used in the present invention.

In various embodiments, the alkylamine may be n-propylamine, n-butylamine, n-pentylamine, n-hexylamine, n-octylamine or n-dodecylamine.

In one embodiment, the alkylamine is n-octylamine.

The dye molecule may be any one of the (modified) dye molecules as described above. The dye molecule may be reacted with a bifunctional linker molecule for connecting to the repeat unit (III) of the polymer. The bifunctional linker molecule has been discussed in detail above.

For example, the dye molecule may be a modified IR-820 dye having the following structure:

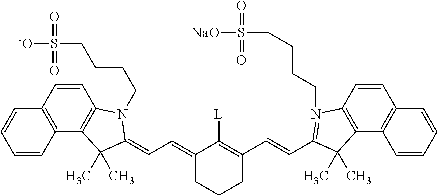

wherein L denotes a linker group for connecting the dye molecule to the remainder of the repeat unit (III) or denotes the attachment point to the remainder of the repeat unit (III), and L has been defined as above.

In one embodiment, the dye molecule is

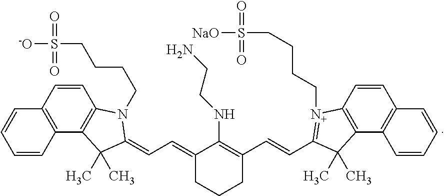

Advantageously, the maleic anhydride polymer of formula (IV) is reacted with the dye molecule and the alkylamine in the presence of an organic solvent in a one-pot reaction. In various embodiments, the organic solvent is anhydrous tetrahydrofuran (THF), anhydrous dimethylformamide (DMF), or a mixture thereof.

In the process of forming a polymer according to the invention, the reaction between the maleic anhydride polymers of formula (IV), the dye molecule and the alkylamine may be carried out in the presence of a base. Generally, any base suitable for the intended purpose may be used. In one embodiment the base is a nucleophilic base. A nucleophilic base is a base having basic properties as well as nucleophilic properties. Illustrative examples include, but are not limited to, diisopropylethyl amine (Hiinig's base), lithium diisopropylamide, lithium tetramethylpiperidide, 1,5-diazabicyclo[4.3.0]-non-5-ene, 1,8-diazabicyclo[5.4.0]undec-7-ene, a bis(trimethylsilyl)amide, a hexamethyldisilazane and bismesitylmagnesium.

In further aspects of the present invention, a method of producing a nanoparticle comprising on its surface a polymer of the first aspect and a nanoparticle produced thereof are provided. The method comprises:
(i) providing a nanoparticle in a suitable solvent, wherein the nanoparticle is a magnetic nanocrystal,
(ii) contacting the nanoparticle with a polymer of the first aspect, and
(iii) allowing interaction between the polymer and the nanoparticle, thereby forming the nanoparticle comprising on its surface said polymer.

The term nanocrystal as used in the present invention may be considered as any nanomaterial with at least one dimension of for example ≦ about 100 nm and that is single-crystalline. These materials are of huge technological interest since many of their electrical and thermodynamic properties show strong size dependence and can therefore be controlled through careful manufacturing processes.

In accordance with the invention, any suitable type of nanocrystal can be rendered water soluble, so as long as the surface of the nanocrystal can interact, for example, via hydrophobic-hydrophobic interactions with the present polymer as described herein.

Advantageously, the nanoparticle is a magnetic nanocrystal such that it may be used, for example, as an imaging agent in magnetic resonance imaging or bioimaging. Thus, the present bimodal imaging agent possesses both magnetic and luminescence properties which may be used for bioimaging purposes and does not have any toxic effects associated with conventional CdSe-based imaging agents. While the present discussion describes the nanoparticle being formed of a magnetic nanocrystal, it is to be understood and appreciated that non-magnetic nanocrystals may also be used to form nanoparticles comprising on its surface the present dye-functionalized polymer.

In various embodiments, the magnetic nanocrystal comprises a material selected from the group consisting of iron, cobalt, nickel, niobium, and magnetic iron oxides and hydroxides such as maghemites, magnetites, and feroxyhytes.

In one embodiment, the magnetic nanocrystal comprises or consists of magnetite (Fe₃O₄).

In yet another embodiment, the nanoparticle comprises on its surface a polymer having the following structure:

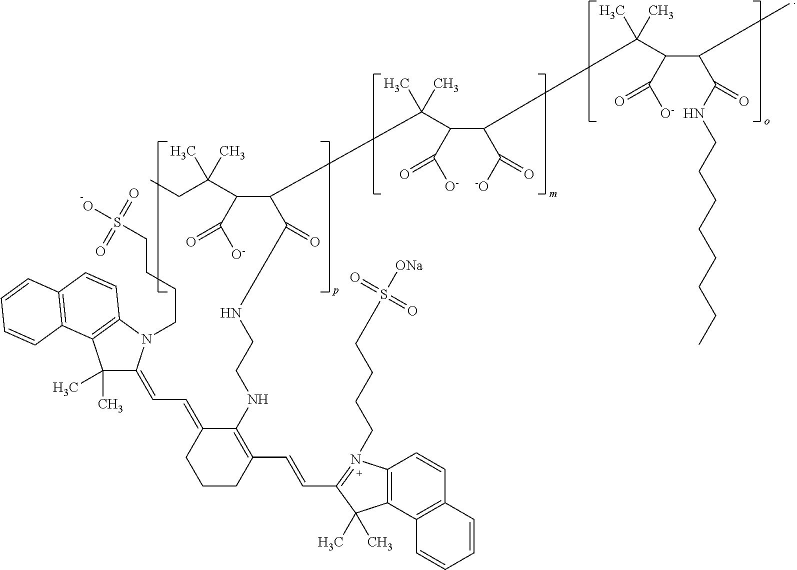

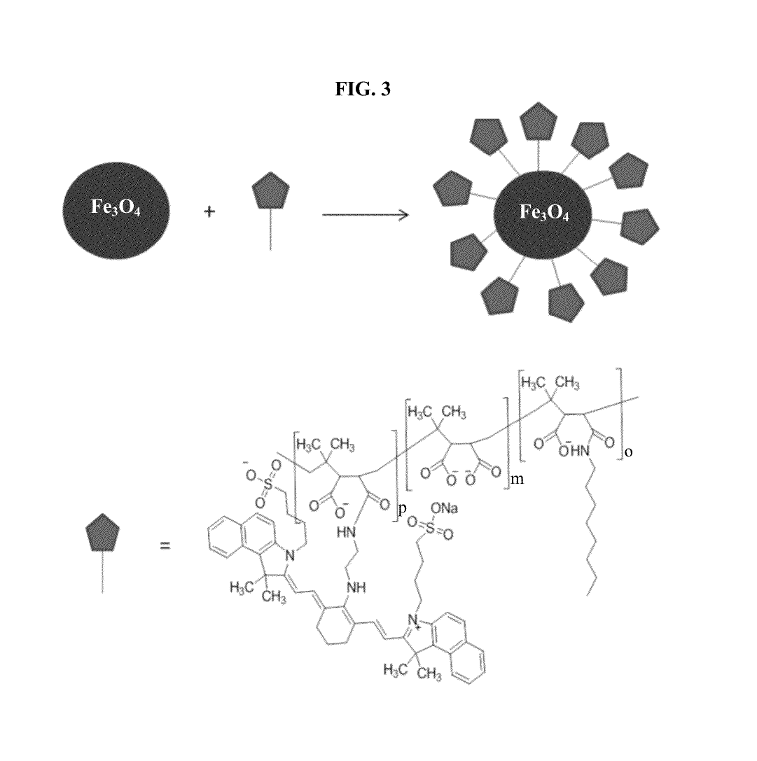

In various embodiments, the nanoparticles suspended in THF are mixed in water with the dye-functionalized polymer. The mixture was concentrated by evaporation of THF and water. The flask was not immersed in a water bath to prolong the water evaporation and allow the evaporating solvents cooling to below 10° C. As a result, a plurality of dye-functionalized polymers are wrapped around the nanocrystal, as illustrated in FIG. 3.

In sum, the present technology discloses a nanoparticle polymeric coating for hydrophobic/hydrophobic interactions used in a hybrid NIR-dye system. The herein described methods allow functionalization of magnetic nanoparticles in a convenient way by using hybrid coating agents comprising dye-functionalized polymers. The luminescence properties of magnetic nanoparticles are preserved, and there is no toxicity, and no assembly or aggregation of the magnetic nanoparticles was observed. The methods are also cost-effective.

In order that the invention may be readily understood and put into practical effect, particular embodiments will now be described by way of the following non-limiting examples.

### EXAMPLES

Method and Results

Synthesis of IR820dye-NH₂

IR-820 (0.500 g, 0.58 mmol) was added into a 100 ml three-necked round-bottomed flask (RBF) connected to a Schlenk line. The dye was dried in vacuum for 15 min and subsequently purged with argon for another 15 min. Anhydrous dimethylformamide (DMF) (2 ml) was added to the RBF. The mixture was stirred at room temperature. Ethylenediamine (3.596 g, 59.83 mmol) and butyllithium (BuLi) (0.8 ml, 2 mmol) in 2.5 M hexane which were prepared in glove box were added dropwise to the mixture at low temperature. The mixture was warmed to room temperature and stirred overnight. The red solution thus obtained was pump-dried. The crude product was purified by column chromatography on silica gel (dichloromethane/ethanol 6:4) to afford a glossy green solid. Yield: 0.463 g (0.53 mmol, 91%).

The characterization results of compound IR820dye-NH₂ are shown below. The formation of IR820dye-NH₂ was confined by ¹H NMR, ¹³C{¹H} NMR, Maldi-TOF and FTIR:

¹H-NMR (400 MHz, DMSO-d₆): δ 1.79 (m, 4H), 1.87 (m, 6H), 1.93 (s, 12H), 2.52 (t, J=7.2 Hz, 4H), 2.87 (m, 4H), 3.42, (m, 2H), 4.35 (m, 6H), 6.39 (d, J=14 Hz, 2H), 7.50(t, J=7.6 Hz, 2H), 7.64, (t, J=7.6 Hz, 2H), 7.80 (d, J=8.8 Hz, 2H), 8.06 (t, J=9.0 Hz, 4H), 8.28 (d, J=8.4 Hz, 2H), 8.34 (d, J=14.4 Hz, 2H)

¹³C{¹H}-NMR (100 MHz, DMSO-d₆): δ 174.3, 142.9, 140.7, 134.5, 132.4, 131.3, 130.8, 128.6, 128.4, 127.3, 125.8, 123.1, 112.7, 102.2, 56.9, 51.6, 44.9, 27.9, 27.2, 26.8, 23.4, 19.4.

MS (MALDI-TOF, positive mode) m/z (%): 873.7 [M+H]⁺

FTIR=3500-3100 cm⁻¹: N—H stretch and 1550-1450 cm⁻¹: N—H bend

Synthesis of Dye-Pol 1

A mixture of poly(isobutylene-alt-maleic anhyride) (0.099 g) (Mw=6000 g/mol), n-octylamine (0.2 ml, 0.15 mmol), diisopropylethylamine (DIPEA) (1 ml) were suspended in anhydrous tetrahydrofuran (THF) (20 ml) and stirred for 30 mins at room temperature. IR820dye-NH₂ (0.463 g, 0.53 mmol) in 20 ml THF and 2 ml DMF was added to the mixture and continued stirring at room temperature overnight. THF was evaporated. The mixture was suspended in water with slightly excess of sodium hydroxide (NaOH) which corresponded to the amount of carboxylic groups in the polymer backbone. The resultant mixture was dialyzed against 0.01 M solution of NaOH for one day and pure water for a few days (membrane cut-off 6000D). Polymer crystals were obtained after freeze-drying.

The characterization results of compound Dye-Pol 1 are shown below.

Yield: 0.10 g

¹H-NMR: δ_{H} (400 MHz, CD₃OD): 8.55-7.35 (br), 6.38 (d, J=14.4 Hz), 5.91 (d, J=13.2 Hz), 4.35 (t, J=7.2 Hz), 4.22 (dd, J=1.6 Hz, J=5.6 Hz), 4.12 (br), 4.01 (d, J=5.6 Hz), 3.84 (t, J=6.6 Hz), 2.94-2.89 (br), 2.04-1.97 (br), 1.41-1.32 (br), 0.95-0.91 (br).

Composition-percentage of functional groups: functional dye 40%, carboxylic 47%, n-octylamide 13%.

To characterize the polymer, ¹H NMR spectra were compared by the referenced spectra of poly(isobutylene-alt-maleic anhydride) with the anhydride groups opened to carboxylate by reacting with stoichiometric amounts of NaOH. The ¹H NMR spectrum integration was integrated to the backbone 6000 g/mol (n=38) where the sample consists of p=12, m=14 and o=4. The signals CH₃ from heterocyclic of the functional dye 2.05-1.98 ppm range were used to calculate the number of functional dye, the alkyl signal CH₂ at 1.22 ppm was served to find the number of n-octylamide chains. The CH₃ terminal signals of polymer at 0.96-0.80 ppm used as a backbone reference. The average number molar mass of the polymer was 18,000 g/mol (calculated based on ¹H NMR).

Synthesis of Dye-Pol 2

The synthetic procedure was similar to the synthesis of Dye-Pol 1 with a mixture of poly(isobutylene-alt-maleic anhyride) (0.044 g) (Mw=60, 000 g/mol), n-octylamine (0.1 ml, 0.07 mmol), DIPEA (1 ml) and IR820dye-NH₂ (0.183 g, 0.21 mmol). The membrane cut off 60000D was used in the dialysis process.

The characterization results of compound Dye-Pol 2 are shown below.

Yield: 0.05 g

¹H-NMR: δ_{H} (400 MHz, CD₃OD): 8.29-7.48 (br), 6.38 (d, J=14.4 Hz), 5.91 (d, J=13.2 Hz), 4.35 (t, J=7.2 Hz), 4.22 (dd, J=2.0 Hz, J=5.6 Hz), 4.12 (br), 4.00 (d, J=5.6 Hz), 3.83 (t, J=6.6 Hz), 2.94-2.81 (br), 2.05-1.98 (br), 1.36-1.29 (br), 0.97-0.91 (br).

Composition-percentage of functional groups: functional dye 26%, carboxylic 61%, n-octylamide 13%.

¹H-NMR spectrum integration was integrated to the backbone 60,000 g/mol (n=380) where the sample consists of p=100, m=230 and o=50.

The average number molar mass of the polymer was 120,000 g/mol (calculated based on ¹H NMR).

Coating of MNPs with Dye-Pol 1 and Dye-Pol 2

5 mg of Dye-Pol 1 or Dye-Pol 2 were suspended in THF (10 mL) and 5 mg of MNPs comprising Fe₃O₄ in 5 mL deionized water. The mixture was concentrated by using a rotary evaporator to 5 mL volume. The water evaporation took longer period because the flask was not immersed in a water bath and it allowed the evaporating solvents cooling to below 10° C. This method was slightly modified from Jariczewski et al., Chem. Commun., 2010, 46:3253-3255. The concentration of the solution was 1 mg/mL.

Cell Culture

HeLa human cervix adenocarcinoma cells were grown in Dulbecco's Modified Eagle Medium (DMEM) supplemented with 10% foetal bovine serum (FBS), 100 U/mL penicillin and 100 μg/mL streptomycin and cultured in a 5% carbon dioxide (CO₂) humidified atmosphere at 37° C.

Cell Viability Assay

10⁴ HeLa cells per well were seeded in a 96-well plate. Following incubation overnight, cell culture medium was removed and 100 μL of MNP samples diluted in serum free DMEM were added to the cells. The MNP samples were then removed after 6 h of incubation at 37° C. and the treated cells were washed with phosphate buffered saline (PBS). Complete DMEM was added and the cells were cultured for another 48 h. Thereafter, 20 μL of CellTiter-Blue® was added to the cells. After incubation at 37° C. for 3 h, the fluorescence was measured at 595 nm with excitation at 560 nm using a Tecan Infinite 200 microplate reader. The results were expressed in percentage based on the control with untreated cells. For the 24 h incubation experiment, 2×10⁴ cells per well were seeded in a 96-well plate. Following incubation overnight, culture medium was removed and 100 μL of MNP samples in serum free DMEM were added to the cells for 24 h. Subsequently, the cell viability assay was carried out as described above. All experiments were performed in triplicates.

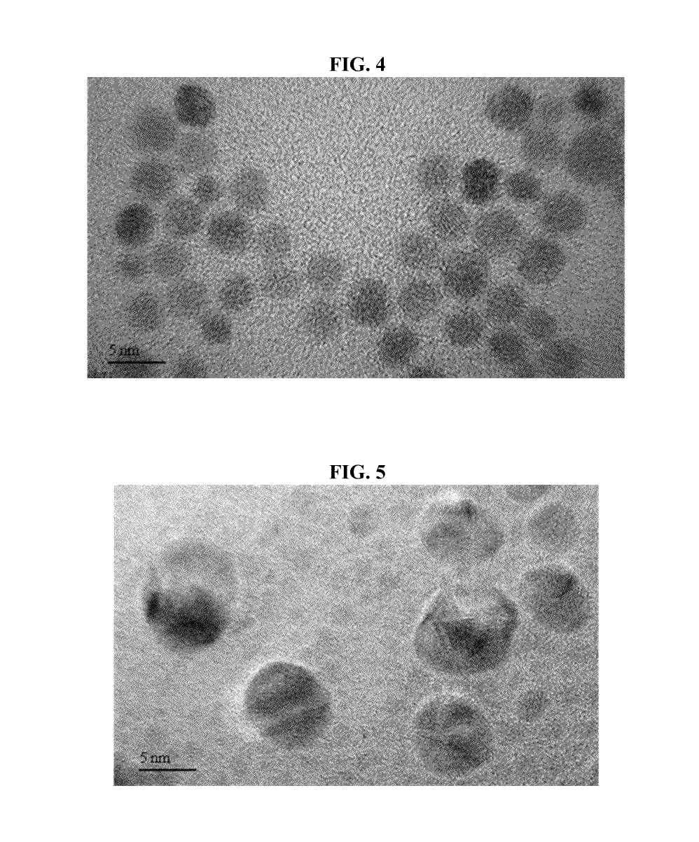

High resolution transmission electron microscopy (HRTEM) illustrates the magnetic nanoparticles coated with Dye-Pol 1 or Dye-Pol 2 (FIG. 4 and FIG. 5). The MNPs were single crystalline and monodispersed.

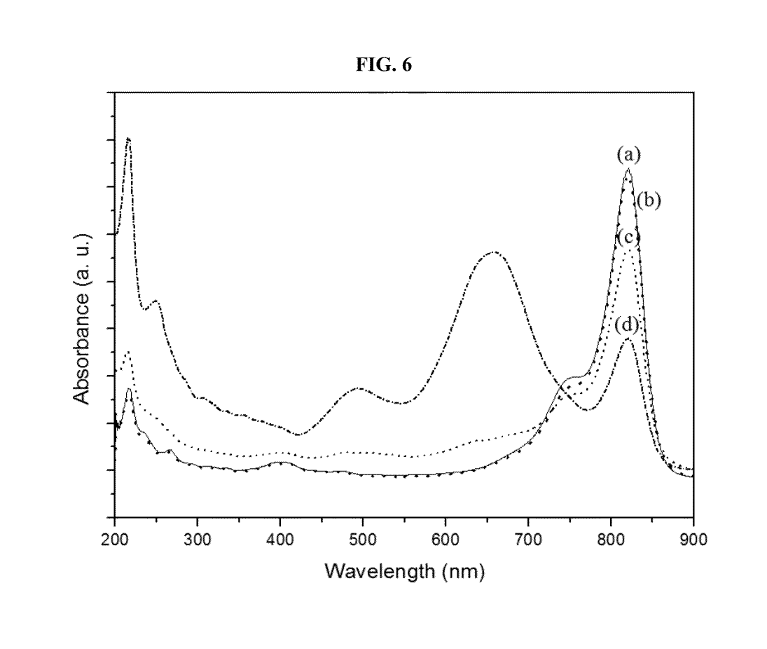

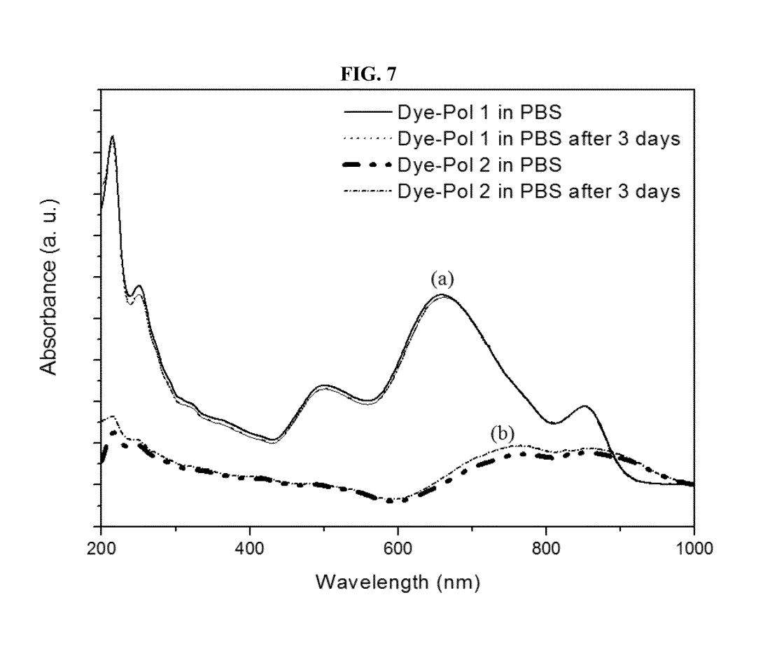

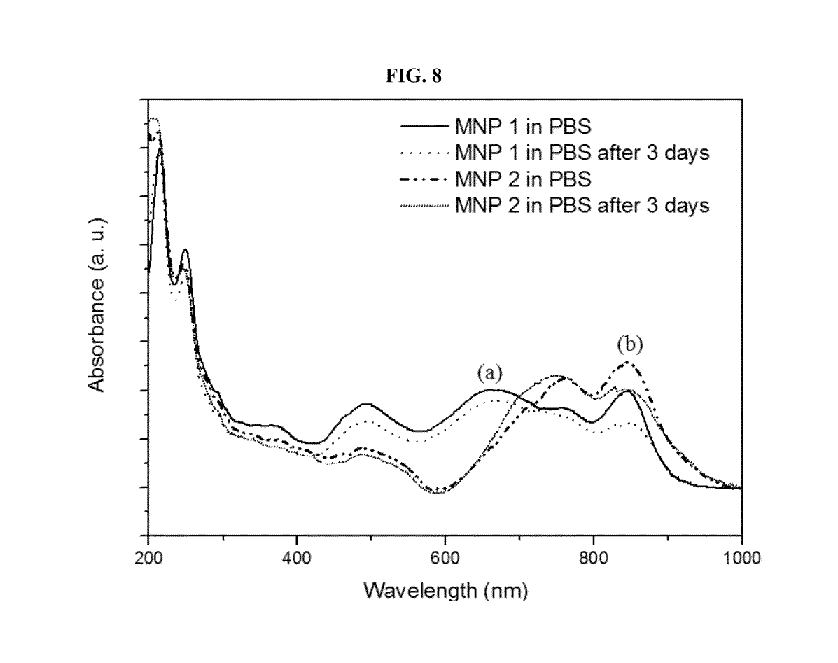

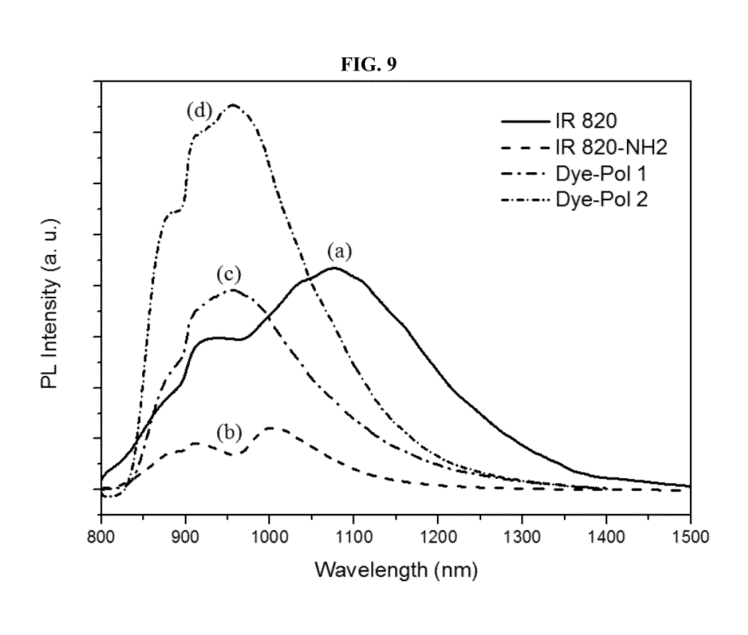

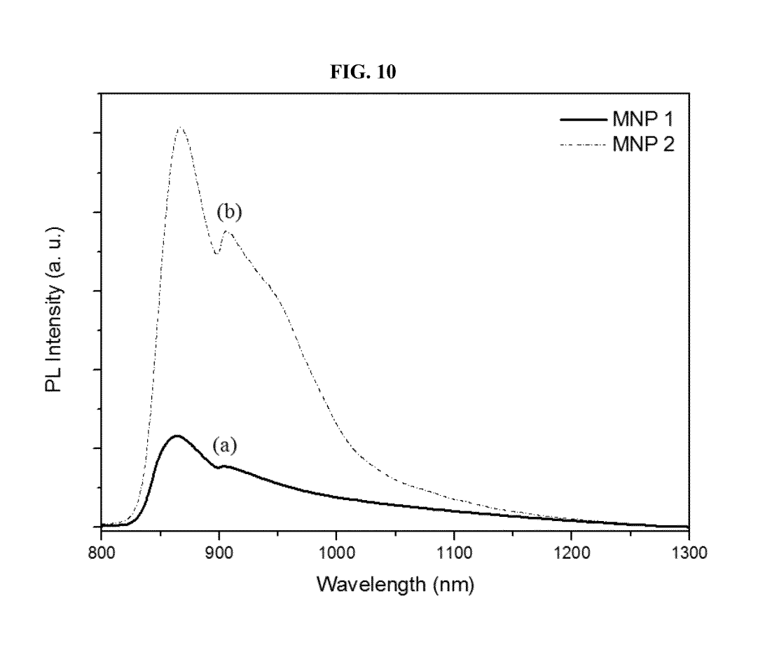

FIG. 6 shows the absorption spectra of IR-820, IR820dye-NH₂, Dye-Pol 1 and Dye-Pol 2 in methanol solution. The absorbance bands of these spectra still remain at 820 nm after chemical modification and hybridization with polymers. The colloidal stability and aggregation were tested by using UV absorbance. Dye-Pol 1 and Dye-Pol 2 were mixed with phosphate buffered saline (PBS) buffer. The absorbance bands remain the same after 3 days (FIG. 7). Similar phenomenon happened to MNP 1 and MNP 2 (FIG. 8). There are no extra peaks for the UV absorbance, resulting they are stable in PBS buffer. FIG. 9 and FIG. 10 show the emission spectra in the near-infrared region (800-1500 nm), excited at 785 nm. The emission spectrum of IR820dye-NH₂ is 1002 nm, slightly blue-shifted from 1076 nm (IR-820). Dye-Pol 1 and Dye-Pol 2 show the emission highest peak at 956 nm while the emission of MNP 1 and MNP 2 are 864 and 866 nm, respectively. Dye-Pol 1 and Dye-Pol 2 absorb at 820 nm and emit at 956 nm. They display a large Stokes shift (136 nm).

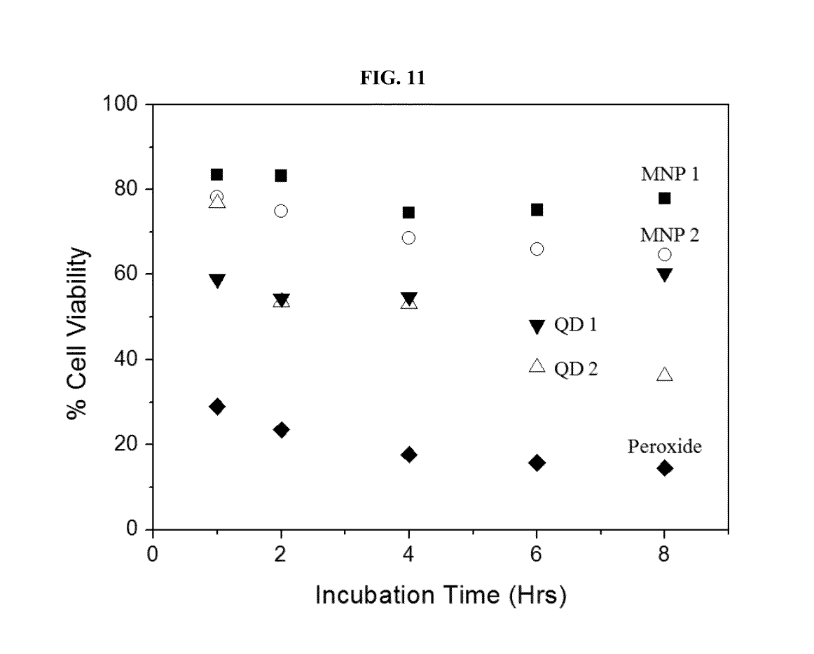

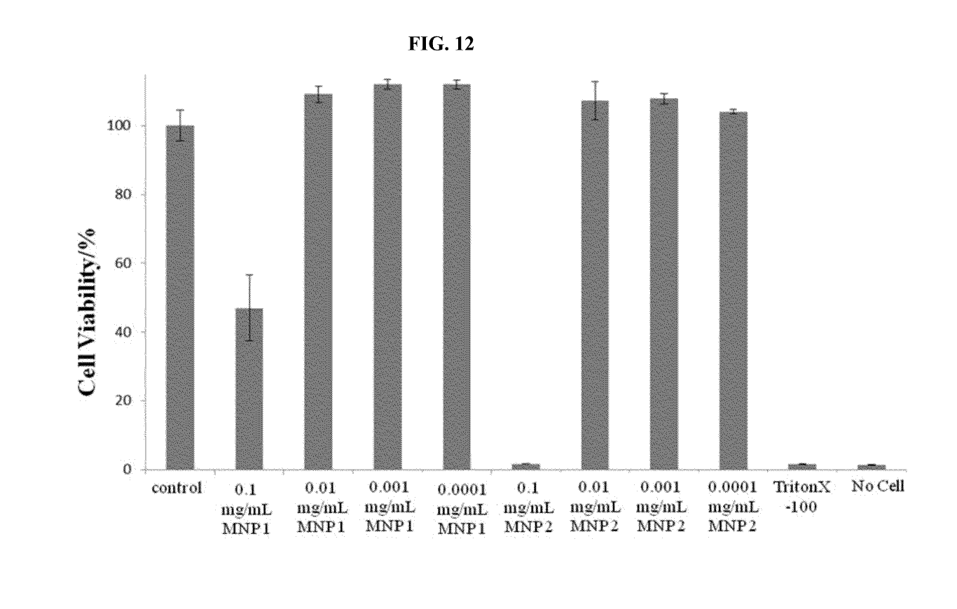

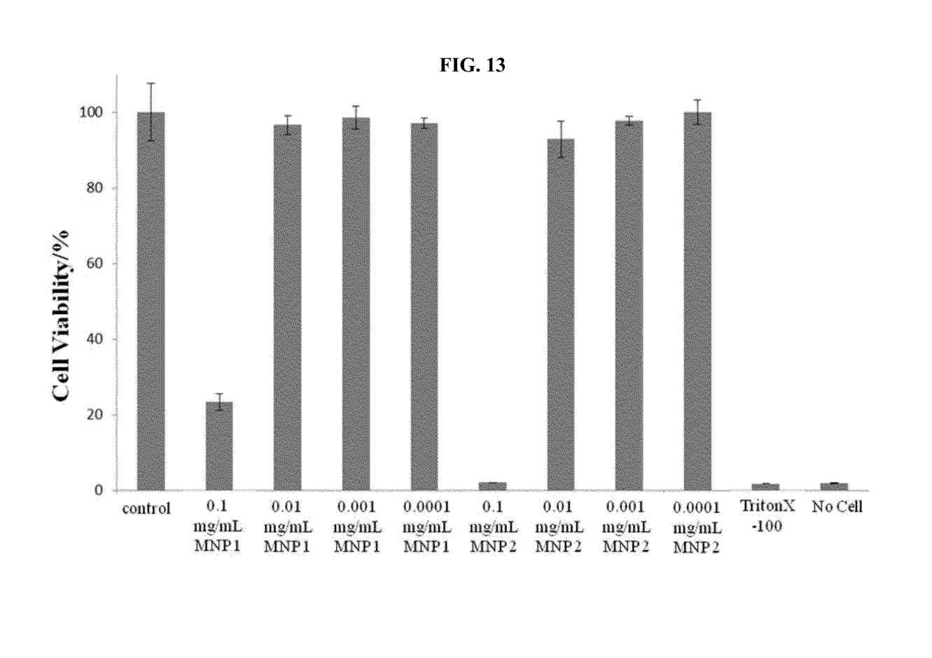

The cytotoxicity effect of MNP 1 and MNP 2 were investigated and compared with CdSe quantum dots (QDs) coated with similar polymers since the toxicity of CdSe QDs is an issue (FIG. 11). They were exposed to HeLa cells in the period of 8 hours for cell viability study. MNP 1 and MNP 2 were better than QD 1 and QD 2, respectively, which were coated with similar polymers. Further works of HeLa cells were used to investigate the cytotoxicity test in different concentrations. FIG. 9 and FIG. 10 show the cell viability assay after 24 hours and 48 hours incubation, respectively. MNP 1 was less toxic compared to MNP 2.

In sum, advantageously the functionalized NIR-dye with alkylamine group (IR820dye-NH₂) can be synthesized in a one-pot reaction, providing convenience and high yield at the same time. In addition, the NIR-dye eliminates the toxicity problem related to conventional CdSe QDs. Furthermore, the hybrid dye-polymer coating agent enhances the colloidal stability and avoids MNPs aggregation. The MNPs coated with these hybrid coating materials become water soluble MNPs with good colloidal stability. The overall effect helps in magnetic resonance imaging.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numberical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non- limiting examples. In addition, where features or aspects of the invention are described in terms of Markush groups, those skilled in the art will recognize that the invention is also thereby described in terms of any individual member or subgroup of members of the Markush group.

1. A polymer comprising repeat units of the general formulae (I), (II) and (III): 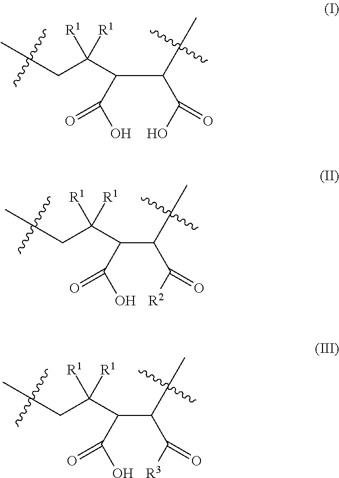
or salts thereof,
wherein:
the repeat unit of general formula (I) is comprised in the polymer with a number of m units, the repeat unit of general formula (II) is comprised in the polymer with a number of o units and repeat unit of general formula (III) is comprised in the polymer with a number of p units, wherein each of m, o and p is an independently selected integer from about 3 to about 400 and wherein the sum of m+o+p is selected in the range from about 10 to about 10,000,
R¹ in repeat units (I) to (III) is H or methyl,
R² in repeat unit (II) is an aliphatic moiety with a main chain of about 3 to about 30 carbon atoms and 0 to about 3 heteroatoms selected from the group N, 0, S, Se and Si, and,
R³ in repeat unit (III) is an optionally substituted dye molecule.

2. The polymer according to claim 1, wherein the dye molecule is modified IR-820 dye having the following structure 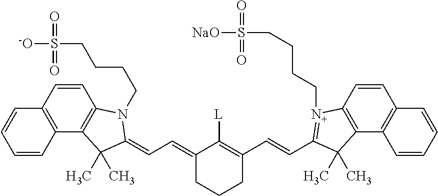
wherein L denotes a linker group for connecting the dye molecule to the remainder of the repeat unit (III) or denotes the attachment point to the remainder of the repeat unit (III).

3. The polymer according to claim 2, wherein L is a linker group selected from the group consisting of —OR⁴, —NR⁴R⁵, —SR⁴, —O—C(O)—R⁴, and —R⁴,
wherein:
R⁴ is selected from the group consisting of —(CH₂)ₖ—, —(CH₂)ₖ—O—, —(CH₂)ₖ—NR⁵—, —(CH₂)ₖ—S—, and —(CH₂)ₖ—C(O)—O—,
R⁵ is hydrogen or C₁-C₆ alkyl, and
k is an integer from 1 to 10.

4. The polymer according to claim 3, wherein R³ is 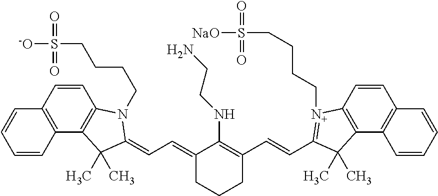
wherein the symbol “*” denotes the point at which R³ is connected to the remainder of the repeat unit (III).

5. The polymer according to claim 1, wherein R² is —NRR′, —OR, or —SR, with R being selected from the group consisting of C₂-C₁₅ alkyl, C₂-C₁₅ alkenyl, and C₂-C₁₅ alkynyl, and R′ being hydrogen or C₁-C₆ alkyl, with the alkyl, alkenyl and alkynyl groups being optionally substituted.

6. The polymer according to claim 5, wherein R² is an —NH(CH₂)₇CH₃.

7. The polymer according to claim 1, having the following structure

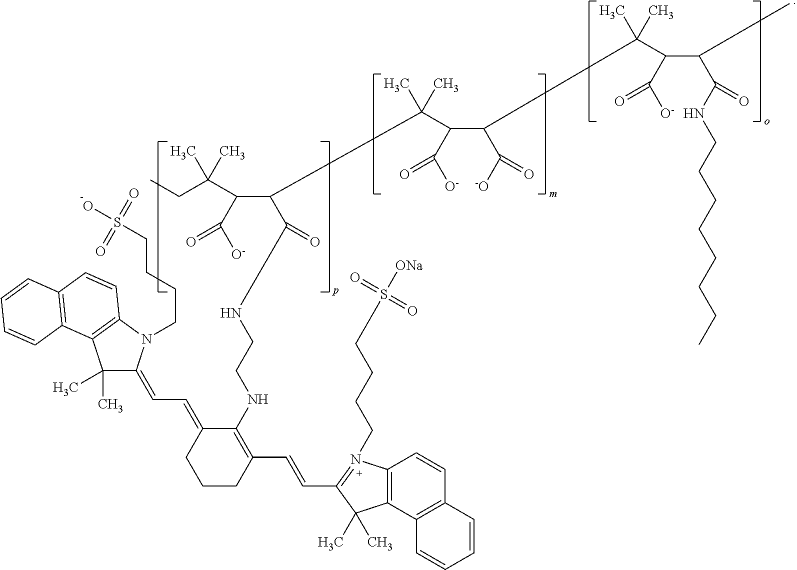

8. A nanoparticle comprising on its surface a polymer according to claim 1, wherein the nanoparticle is a magnetic nanocrystal.

9. The nanoparticle according to claim 8, wherein the magnetic nanocrystal comprises a material selected from the group consisting of iron, cobalt, nickel, niobium, and magnetic iron oxides and hydroxides such as maghemites, magnetites, and feroxyhytes.

10. The nanoparticle according to claim 9, wherein the magnetic nanocrystal comprises or consists of magnetite.

11. The nanoparticle according to claim 10, wherein the nanoparticle comprises on its surface a polymer having the following structure

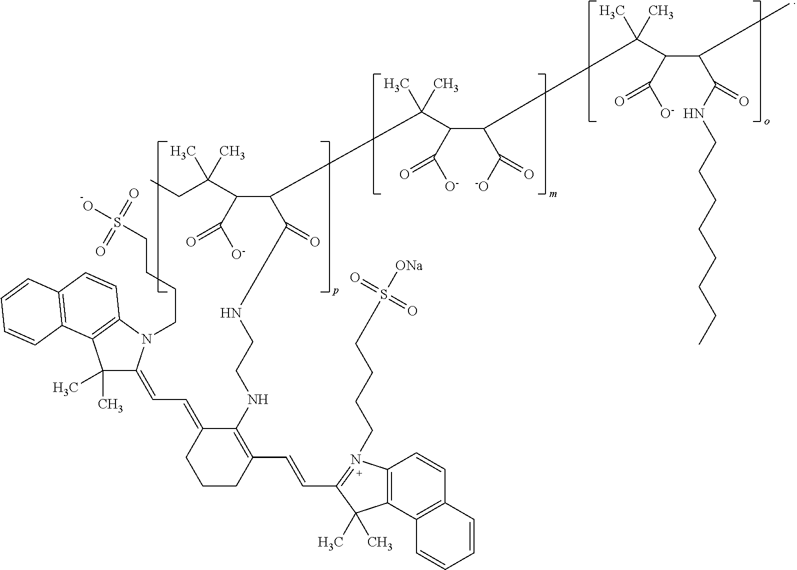

12. A method of producing a polymer according to claim 1, comprising reacting in a suitable solvent a maleic anhydride polymer of formula (IV), 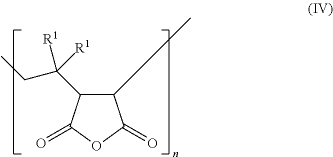
with an optionally substituted dye molecule and an alkylamine,
wherein:
n is an integer from about 10 to about 10,000, and
R¹ is H or methyl.

13. The method according to claim 12, wherein the dye molecule is modified IR-820 dye having the following structure 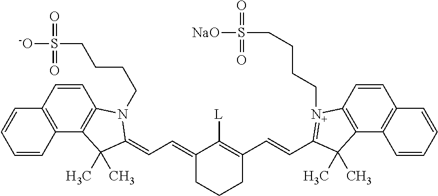
wherein L denotes a linker group for connecting the dye molecule to the remainder of the repeat unit (III) or denotes the attachment point to the remainder of the repeat unit (III).

14. The method according to claim 13, wherein L is a linker group selected from the group consisting of —OR⁴, —NR⁴R⁵, —SR⁴, —O—C(O)—R⁴, and —R⁴, wherein:
R⁴ is selected from the group consisting of —(CH₂)ₖ—, —(CH₂)ₖ—O—, —(CH₂)ₖ—NR⁵—, —(CH₂)ₖ—S—, and —(CH₂)ₖ—C(O)—O—,
R⁵ is hydrogen or C₁-C₆ alkyl, and
k is an integer from 1 to 10.

15. The method according to claim 14, wherein the dye molecule is

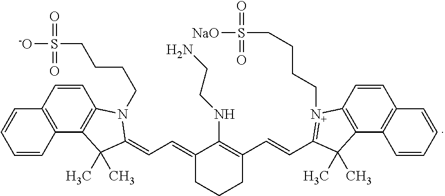

16. The method according to claim 15, wherein the alkylamine is n-octylamine.

17. The method according to claim 12, wherein R² is —NRR′, —OR, or —SR, with R being selected from the group consisting of C₂-C₁₅ alkyl, C₂-C₁₅ alkenyl, and C₂-C₁₅ alkynyl, and R′ being hydrogen or C₁-C₆ alkyl, with the alkyl, alkenyl and alkynyl groups being optionally substituted.

18. The method according to claim 17, wherein R² is an —NH(CH₂)₇CH₃.

19. A method of producing a nanoparticle comprising on its surface a polymer, the method comprising:
(i) providing a nanoparticle in a suitable solvent, wherein the nanoparticle is a magnetic nanocrystal,
(ii) contacting the nanoparticle with a polymer according to claim 1, and
(iii) allowing interaction between the polymer and the nanoparticle, thereby forming the nanoparticle comprising on its surface said polymer.

20. A method of providing an imaging agent for use in magnetic resonance imaging or bioimaging, wherein the imaging agent comprises a nanoparticle of claim 8.
